(19) United States
(12) Patent Application Publication
(10) Pub. No.: US 2013/0293827 A1
(43) Pub. Date: Nov. 7, 2013

(54) GLASSES FRAME

(71) Applicant: HSIN-HUNG KUO, TAINAN CITY (TW)

(72) Inventor: HSIN-HUNG KUO, TAINAN CITY (TW)

(21) Appl. No.: 13/464,129

(22) Filed: May 4, 2012

(51) Int. Cl. G02C 5/14

(52) U.S. Cl. 351/116

(57) ABSTRACT

A glasses frame comprises a body and two temples. Each of the two temples includes a protruding portion, a rod extending downward from the protruding portion, and a guiding block formed at one end of the rod. The body is provided at each end thereof with a protruding portion, a pivot hole penetrating the protruding portion, a guiding groove in communication with the pivot hole, and a stop portion formed at a bottom of the guiding groove. The rods of the two temples are inserted downward into the pivot holes of the body respectively, and the guiding blocks move downward along the guiding grooves and slide over the stop portions and engage against the bottom of the protruding portions, respectively, so that the two temples are pivotally fixed at both ends of the body without using screws, which reduces manufacturing cost while making assembly easier.

### BACKGROUND OF THE INVENTION

1. Field of the Invention

The present invention relates to a glasses frame, and more particularly to a glasses frame whose temples can be quickly and easily assembled to the body of the frame.

2. Description of the Prior Art

A pair of conventional glasses generally consists of two lenses disposed in a frame, and two temples pivoted to the frame by screws. When not in use, the temples can be folded. However, the wearing angle of the conventional glasses is not adjustable to fit different faces. Moreover, it has to use screws to fix the two temples to the frame, which makes the assembly of the glasses complicated, and the screws are tiny and very likely to be lost after the temples are disassembled.

The present invention has arisen to mitigate and/or obviate the afore-described disadvantages.

### SUMMARY OF THE INVENTION

The primary object of the present invention is to provide a glasses frame which comprises a body and two temples.

Each of the two temples includes a protruding portion, a rod extending downward from the protruding portion, and a guiding block formed at one end of the rod.

The body is provided at each of two ends thereof with a protruding portion, a pivot hole penetrating the protruding portion for insertion of the rod, a guiding groove in communication with the pivot hole for guiding sliding of the guiding block, and a stop portion formed at a bottom of the guiding groove.

The guiding blocks slide downward along the guiding grooves and slide over the stop portions and finally engage against a bottom of the protruding portions, respectively, and a bottom of the respective protruding portions of the temples is abutted against a top surface of the respective protruding portions of the body.

The rods of the two temples are inserted downward into the pivot holes of the body respectively, and the guiding blocks slide downward along the guiding grooves. The guiding blocks slide over the stop portions and engage against the bottom of the protruding portions, respectively, so that the two temples are pivotally fixed at both ends of the body without using screws, which reduces manufacturing cost while making assembly easier.

### BRIEF DESCRIPTION OF THE DRAWINGS

FIG. 1 is a perspective view of a glasses frame in accordance with the present invention;

FIG. 2 is an exploded view of a part of the glasses frame in accordance with the present invention;

FIG. 3 is a cross sectional view of a part of the glasses frame in accordance with the present invention, showing that the rod is inserted downward into the pivot hole, and the guiding block is stopped against the stop portion;

FIG. 4 is a cross sectional view of a part of the glasses frame in accordance with the present invention, showing that the temple slides over the stop portion and engages against the bottom of the protruding portion;

FIG. 5 is a cross sectional view of a part of the glasses frame in accordance with the present invention, showing that the engaging tooth is engaged in one of the engaging grooves;

FIG. 6 is a cross sectional view of a part of the glasses frame in accordance with the present invention, showing that the temple is rotated;

FIG. 7 is a cross sectional view of a part of the glasses frame in accordance with the present invention, showing that the rod is inserted into the pivot hole, and the engaging tooth is engaged in one of the engaging grooves; and

FIG. 8 is a perspective view of a glasses frame in accordance with the present invention, showing that two temples are connected with an elastic strap.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

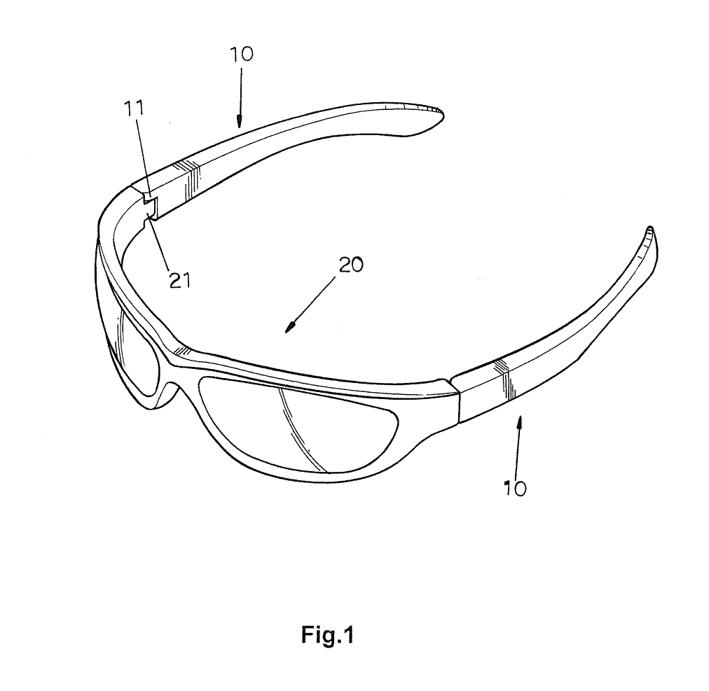

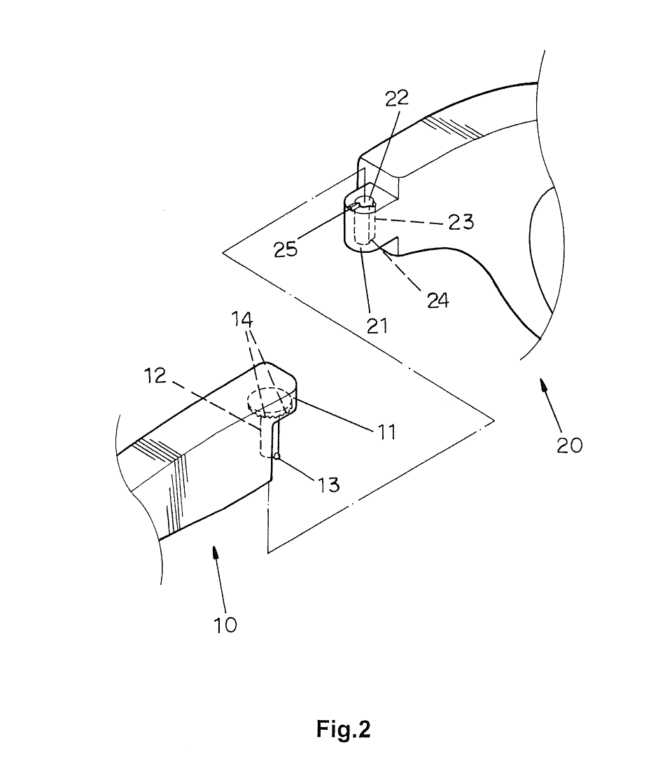

Referring to FIGS. 1 and 2, a glasses frame in accordance with the present invention comprises two temples 10 and a body 20.

Each of the temples 10 includes a protruding portion 11, a rod 12 extending downward from the protruding portion 11, a guiding block 13 formed at one end of the rod 12, and a plurality of annularly-arranged engaging grooves 14 formed on an inner surface of the protruding portion 11.

At each of two ends of the body 20 is formed a protruding portion 21, a pivot hole 22 penetrating the protruding portion 21, a guiding groove 23 in communication with the pivot hole 22, a stop portion 24 formed at the bottom of the guiding groove 23, and an engaging tooth 25 located at the top of the protruding portion 21 and engaged with one of the engaging grooves 14.

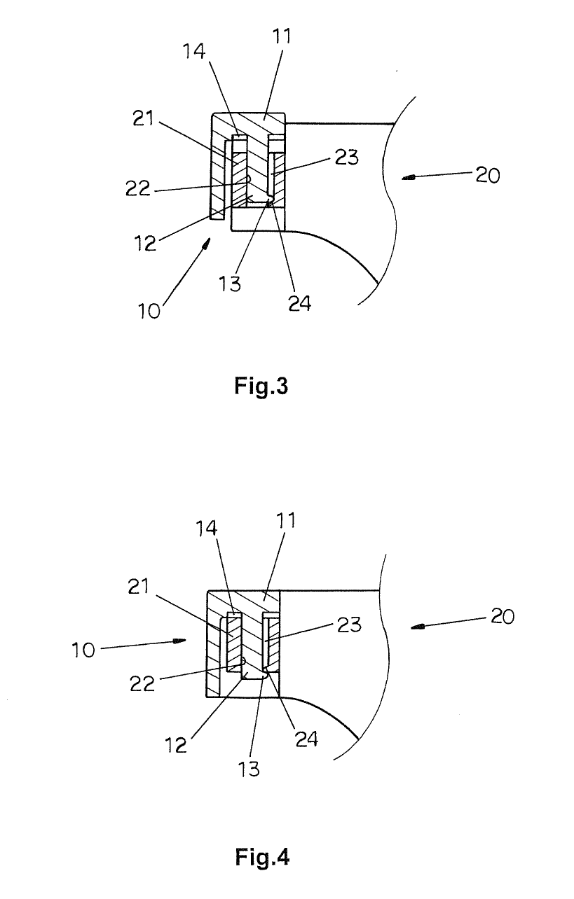

As shown in FIGS. 3 and 4, in assembly, the rods 12 of the two temples 10 are inserted downward into the pivot holes 22 of the body 20 respectively, and the guiding blocks 13 slide downward along the guiding grooves 23. When the guiding blocks 13 are stopped against the stop portions 24, pressing the temples 10 can make the guiding blocks 13 slide over the stop portions 24 and engage against the bottom of the protruding portions 21, respectively. Meanwhile, the bottom of the protruding portions 11 is abutted against the top surface of the protruding portions 21, so that the two temples 10 are pivotally fixed at both ends of the body 20. When the two temples 10 are broken and need to be replaced, the temples 10 can be removed from the body 20 by performing in reverse order, the abovementioned steps, by pulling the temples 10 upward.

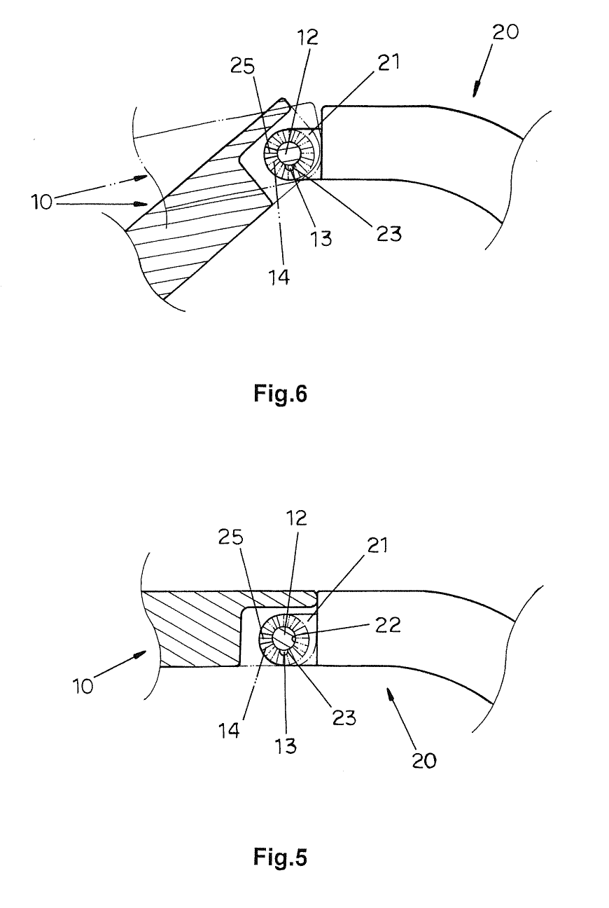

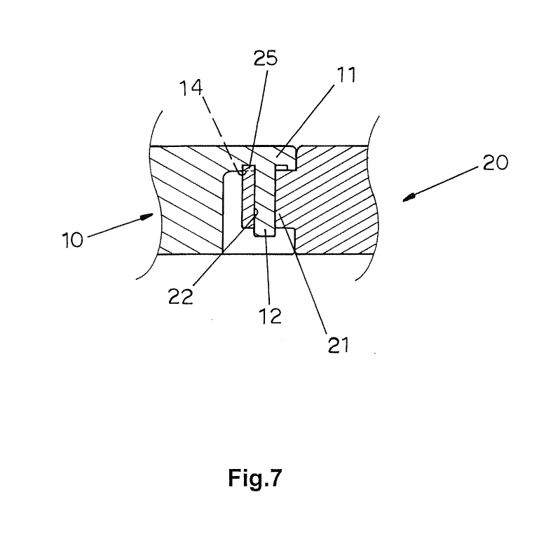

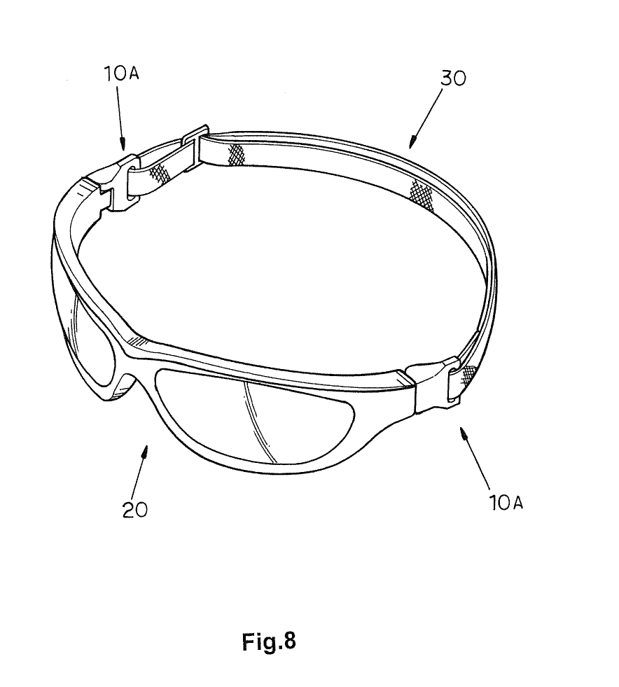

Referring to FIGS. 5-7, when in use, the two temples 10 can be rotated with respect to the body 20 to make the engaging tooth 25 engage in one of the engaging grooves 14, so that the temples 10 can be adjusted at a desired angle with respect to the body 20 to better fit different faces.

Referring to FIG. 8, another embodiment of the present invention is shown, wherein the two temples 10A are connected with an elastic strap 30 which is to be worn around a user's head (not shown). The temples 10A are pivotally connected to the body 20 in the same way as mentioned above but are different in shape and appearance from the temples 10.

To summarize, the present invention has the following advantages:

Firstly, the rods of the two temples 10 are inserted downward into the pivot holes 22 of the body 20 respectively, and the guiding blocks 13 slide downward along the guiding grooves 23. When the guiding blocks 13 slide over the stop portions 24 and engage against the bottom of the protruding portions 21, respectively, the two temples 10 are pivotally fixed at both ends of the body 20 without using screws, which reduces manufacturing cost while making assembly easier.

Secondly, with the engaging tooth 25 selectively engaged in one of the engaging grooves 14, the temples 10 can be adjusted at different wearing angles to better fit different faces.

While we have shown and described various embodiments in accordance with the present invention, it is clear to those skilled in the art that further embodiments may be made without departing from the scope of the present invention.

What is claimed is:

1. A glasses frame comprising:
two temples each including a protruding portion, a rod extending downward from the protruding portion, and a guiding block formed at one end of the rod;
a body provided at each of two ends thereof with a protruding portion, a pivot hole penetrating the protruding portion for insertion of the rod, a guiding groove in communication with the pivot hole for guiding sliding of the guiding block, a stop portion formed at a bottom of the guiding groove;
wherein the guiding blocks slide downward along the guiding grooves and slide over the stop portions and finally engage against a bottom of the protruding portions, respectively, and a bottom of the respective protruding portions of the temples is abutted against a top surface of the respective protruding portions of the body.

2. The glasses frame as claimed in claim 1, wherein a plurality of annularly-arranged engaging grooves is formed on an inner surface of the respective protruding portion, and an engaging tooth is located at a top of the protruding portion of the body and selectively engaged with one of the engaging grooves.
